(19) United States
(12) Patent Application Publication
(10) Pub. No.: US 2015/0332622 A1
(43) Pub. Date: Nov. 19, 2015

(54) Automatic Theme and Color Matching of Images on an Ambient Screen to the Surrounding Environment

(71) Applicant: Google Inc., Mountain View, CA (US)

(72) Inventors: Eric HC Liu, Santa Clara, CA (US); Charles Goran, Morgan Hill, CA (US)

(73) Assignee: Google Inc., Mountain View, CA (US)

(21) Appl. No.: 14/276,969

(22) Filed: May 13, 2014

(51) Int. Cl. G09G 3/20; G06Q 30/02

(52) U.S. Cl. CPC G09G 3/2003; G06Q 30/0256

(57) ABSTRACT

Systems, methods, and computer readable storage mediums are provided for automatically matching the theme of an image on an ambient screen to its surroundings. In some implementations, one or more real time environmental conditions of a room in which a primary display screen is located are evaluated. The primary display screen is controllable by computer system via a network or a client device coupled to it. The environmental conditions include the current time, the current date, the current season, the geographic location, the ambient light level and color temperature, and/or the ambient sound level. A design style associated with the room is identified. Then a media content item having visual characteristics based on the design style and the environmental conditions is sent to the primary display screen for display.

### TECHNICAL FIELD

The disclosed implementations relate generally to providing images on ambient screens in homes, offices, and other environments that fit the mood of the environment.

### BACKGROUND

An immediate environment can have a large functional and emotional impact on a user, and technology in the environment is becoming more and more common. However, technology is often banned because it is seen as distracting. For instance, many parents limit the amount of “screen time” that their children are allowed. The distracting and invasive nature of technology forces people to turn off technology in many environments, like the living room. This limits the ability for technological devices to add value at all times for the user. This is especially true as large screens go beyond 84″ in diagonal. Some reasons that screens are turned off is that they have too much motion, do not fit the mood of the room, are not beautiful, and/or that they show inappropriate topics such as advertisements.

### SUMMARY

The present invention overcomes the limitations and disadvantages described above by providing methods, systems, and computer readable storage mediums for matching the theme of an image on an ambient screen to its surroundings based on a design style associated with a room as well as real time environmental conditions such as: current time, current date, current season, geographic location, ambient light level and color temperature, and ambient sound level.

The following presents a summary of the invention in order to provide a basic understanding of some of the aspects of the invention. This summary is not an extensive overview of the invention. It is not intended to identify key/critical elements of the invention or to delineate the scope of the invention. Rather, this summary presents some of the concepts of the invention in a simplified form as a prelude to the more detailed description that is presented later.

Various implementations of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various implementations are used.

One aspect of the disclosure is a method for automatically matching the theme of an image to its surroundings to be displayed on a primary display screen. The method takes place at a computer system having one or more processors and memory storing programs for execution by the one or more processors. One or more real time environmental conditions of a room in which a primary display screen is located are evaluated. The primary display screen is controllable by computer system via a network or a client device coupled to it. The environmental conditions include the current time, the current date, the current season, the geographic location, the ambient light level and color temperature, and/or the ambient sound level. A design style associated with the room is identified. In some implementations, a color palette associated with the room is also identified. Then a media content item having visual characteristics based on the design style and the environmental conditions is sent to the primary display screen for display. It is noted that in some implementations media content item has visual characteristics that are also based on the color palette.

Some implementations provide a computer system with one or more central processing units, CPU(s), for executing programs and memory storing the programs to be executed by the CPUs. The programs include instructions to perform any of the implementations of the aforementioned image matching method. Some implementations of the computer system also include program instructions to execute the additional options discussed below.

Yet other implementations provide a non-transitory computer readable storage medium storing one or more programs configured for execution by a computer. The programs include instructions to perform any of the implementations of the aforementioned image matching method. Some implementations of a non-transitory computer readable storage medium also include program instructions to execute the additional options discussed below.

Thus, these methods, systems, and storage mediums provide new, more intuitive, and more efficient ways to provide attractive and contextually appropriate images on an otherwise currently unused primary display screen in a room.

### BRIEF DESCRIPTION OF THE DRAWINGS

For a better understanding of the aforementioned aspects of the invention as well as additional aspects and implementations thereof, reference should be made to the Description of Implementations below, in conjunction with the following drawings in which like reference numerals refer to corresponding parts throughout the figures.

FIG. 1 is a block diagram illustrating a distributed computer system for automatically matching the theme of an image on an ambient screen to its room surroundings, in accordance with some implementations.

FIG. 2A is flow diagram illustrating a method for obtaining environmental signals and using them to generate environmentally suitable media content for display on a primary display screen based on the environmental signals, in accordance with some implementations.

FIG. 2B illustrates how image selections may change throughout the day, based at least in part on time of day, in accordance with some implementations.

FIG. 2C is an illustration of an exemplary room including a primary display screen, sensors, a secondary device, and various room items used in determining a room's style and/or color palette, in accordance with some implementations.

FIG. 3 is a block diagram illustrating an example client, in accordance with some implementations.

FIG. 4 is a block diagram illustrating an example server, in accordance with some implementations.

FIG. 5 is block diagram illustrating a data structure of a database of tagged media content items.

FIG. 6 is a flowchart representing a method of providing a media content item for display on a display screen that matches the theme of its surroundings, in accordance with some implementations.

Like reference numerals refer to corresponding parts throughout the drawings.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the present implementations. However, it will be apparent to one of ordinary skill in the art that the present various implementations may be practiced without these specific details. In other instances, well-known methods, procedures, components, and networks have not been described in detail so as not to unnecessarily obscure aspects of the implementations.

Technology is becoming more and more common, but ambient screen images (such as generic screensavers) are often avoided because they are seen as distracting. This forces people to turn off technology devices with screens, which limits the ability for technological devices to add value to the user during non-active times. While some devices have screensavers with beautiful imagery, the imagery is not customized to the user environment. The images are generic and thus are not seen as part of the home, but as part of the computing device. Some devices even advertise for the device itself rather than acting as something a user might actually hang as artwork in their house.

People do not decorate their houses with just any piece of artwork. Some implementations disclosed herein customize the screen of electronic devices to suit the environment in which the screens are located, much as a piece of artwork. This allows the screen to help the user relax and exist as part of the environment as opposed to clashing with it. Specifically, some implementations of this invention use the following signals from the environment to customize the screen to fit:
Time of Day
Photo taken of the room
Temperature and season
User selected palette and theme
Theme from another personal device (phone)

In contrast, some implementations described herein receive inputs from several signals and mix those inputs to create a slideshow of images that fit the criteria and display them on an ambient screen.

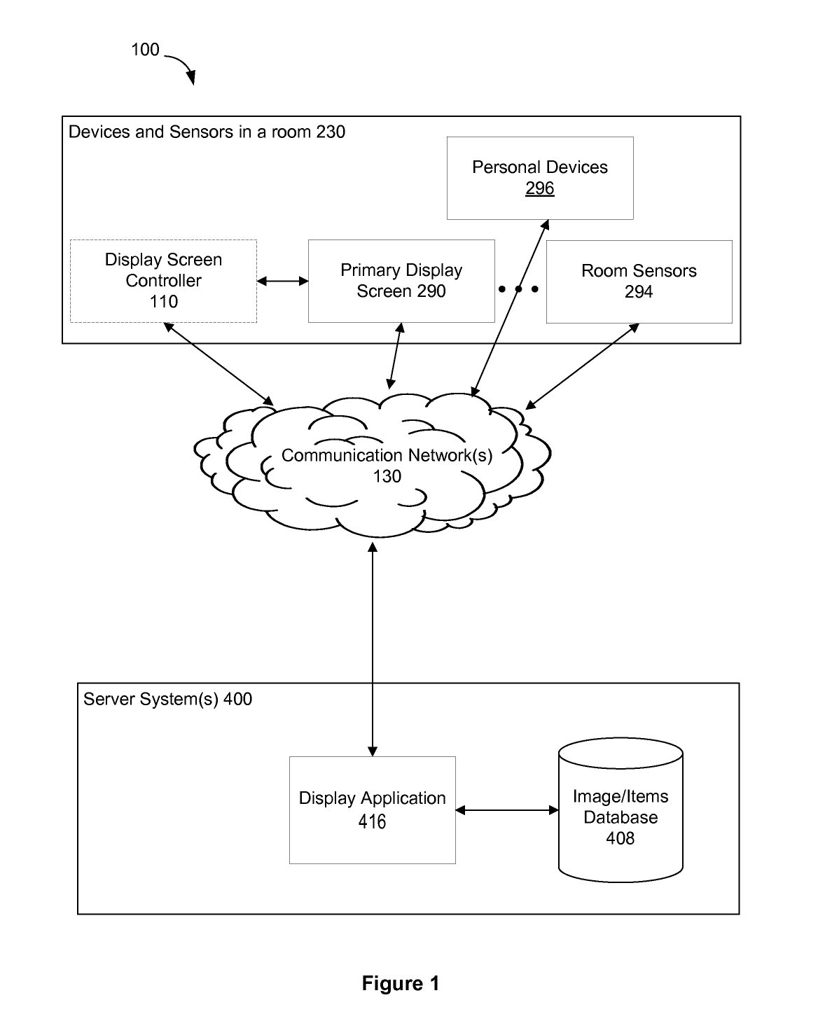

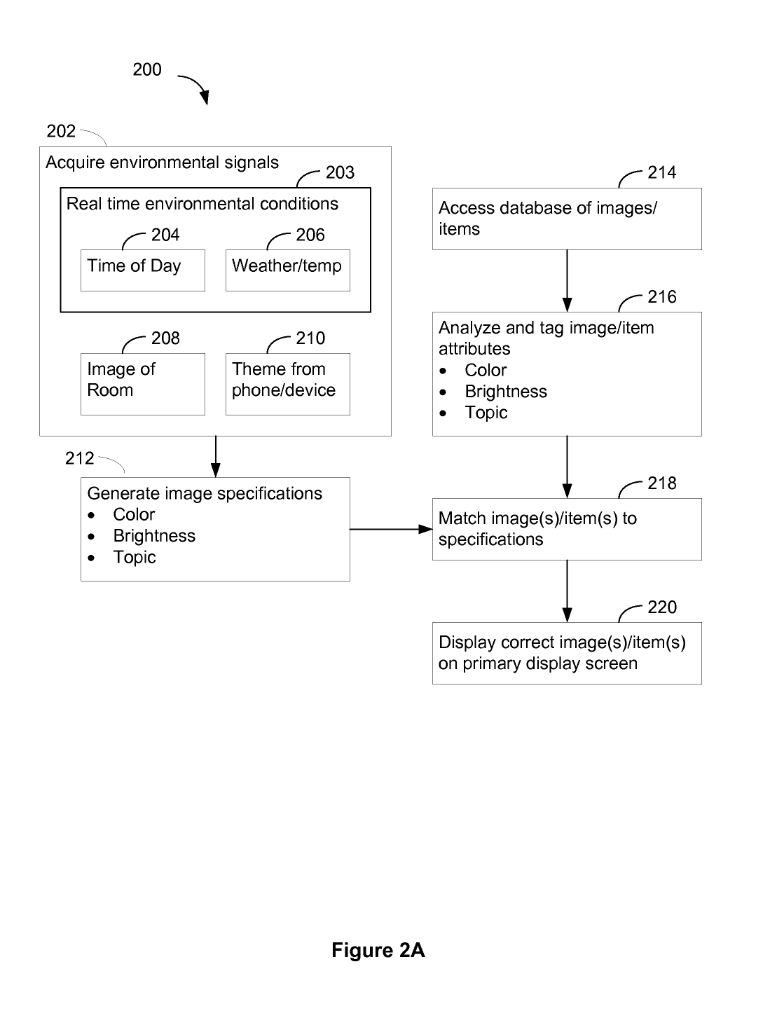

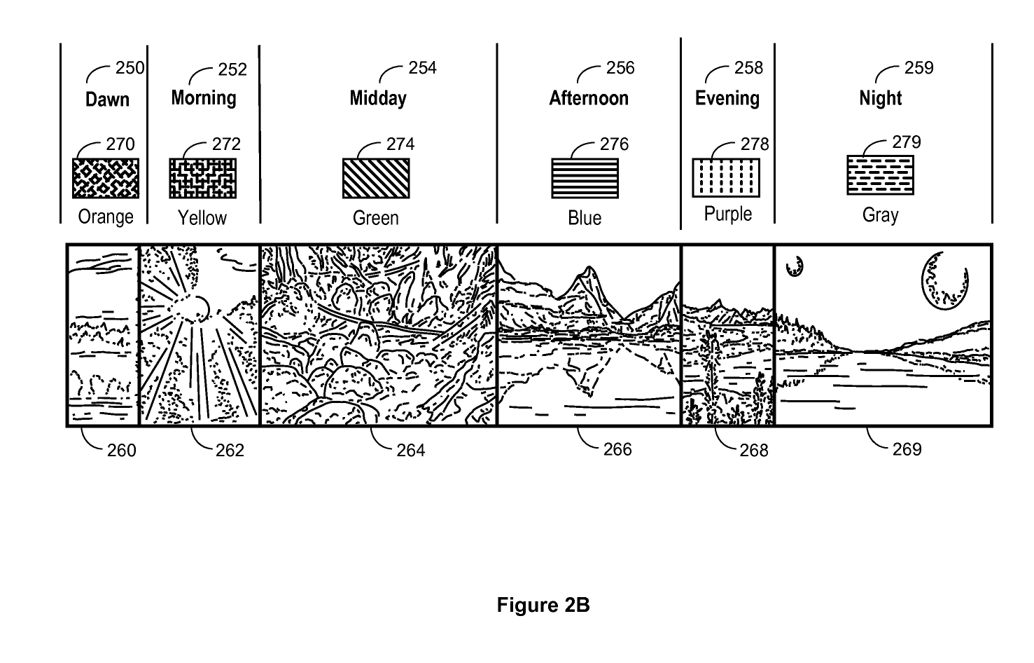

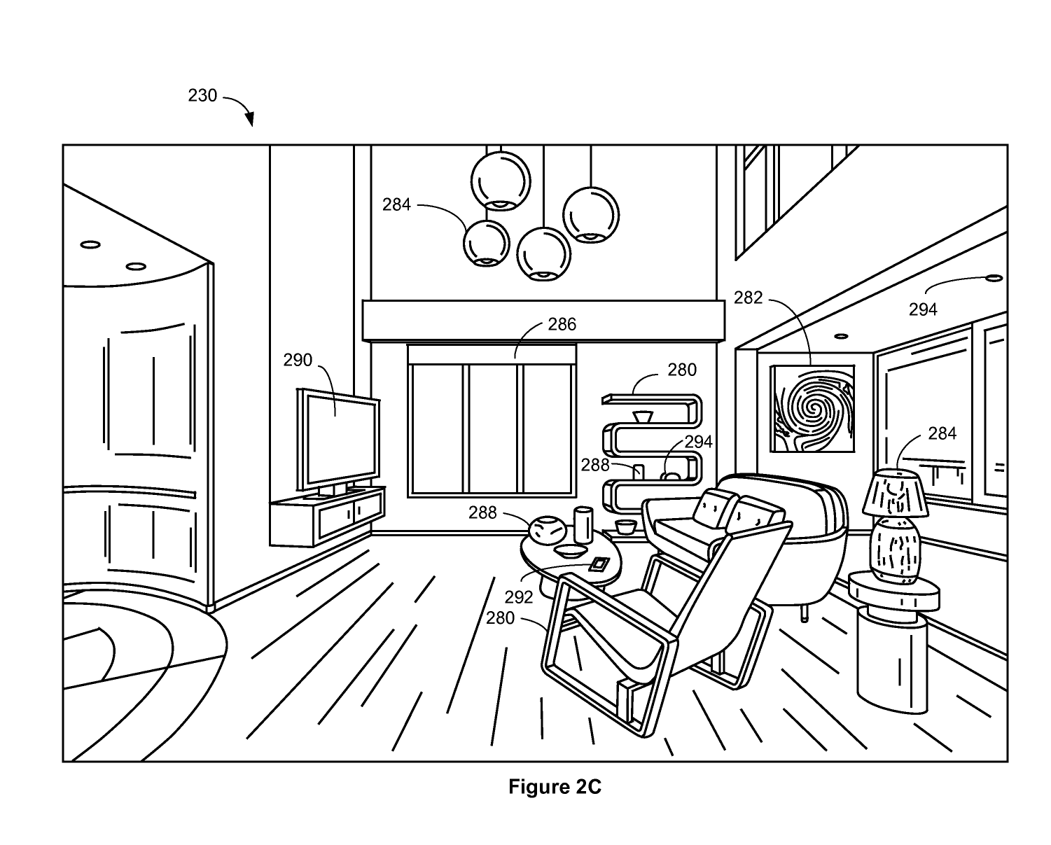

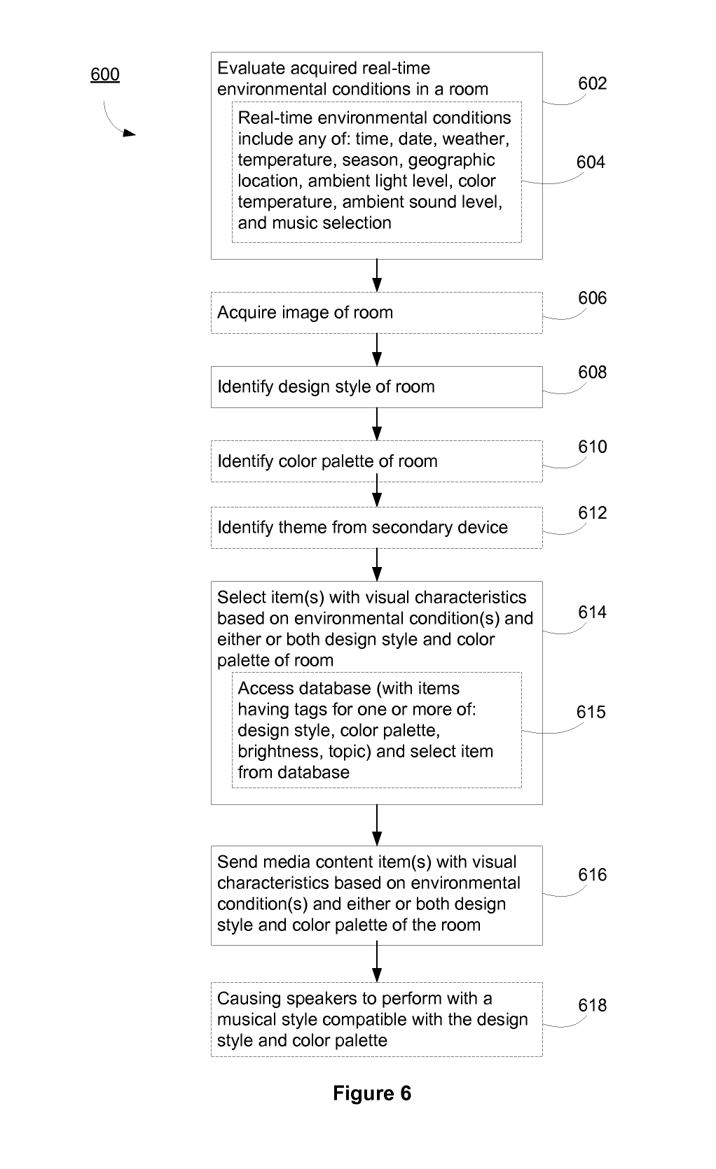

FIG. 1 illustrates a system 100 for automatically matching the theme of an image on an ambient screen to its room surroundings. There are several logical analysis operations performed of by the system 100, which can be implemented by a display application 416 performed on a server (e.g., in one or more servers coupled to one or more devices and sensors in a room 230, such as a living room in a user's home, via the Internet 130). Some of these operations include: determining real-time environmental conditions of a room 230 (e.g., obtained from one or more room sensors 294 and personal devices 296, such as smart phones, laptops and tablet computers); determining a design style associated with the room 230, and sending a thematically appropriate media content item, such as an image, selected from a database of tagged media content items 408, for display on a primary display screen 290 in the room 230 (as discussed in more details with respect to FIGS. 2A and 6). In different implementations, some operations illustrated as being performed by the display application 416 can be performed for a display screen controller 110 which is located on premises (e.g., in a user's house or business). In some implementations, the operations are performed by a combination of the server display application 416 and an on-display screen controller 110. In the following descriptions, no particular system configuration is required and the described implementations are intended merely as non-limiting examples.

FIG. 2A illustrates a system 200 for obtaining environmental signals 202 and using them to generate an environmentally suitable media content item such as an image or slideshow/set of images based on the environmental signals. The specific environmental signals 202 may include but are not limited to: time of day 204, weather/temperature 206, image of the room 208, and theme from a phone 210.

In some implementations, real-time environmental conditions 203 are obtained. These real-time environmental conditions 203 include time of day 204 and weather/temperature 206. These and other environmental conditions influence the choice of appropriate images to display on an ambient screen. Operations are now described for matching images for ambient display to different environment signals, such as Time 204, Weather/temperature 206, Image of a Room 208 and Theme from a Phone/device 210.

### Time of Day 204

With respect to the “Time of Day” condition 204, the photos a user may want to see in the morning are different than what a user may want to see at night.

One mechanism for changing the images based at least in part on the time of day 204 is to use a timestamp associated with candidate photos to match the time of day in the room. For instance, in some implementations, images are displayed at the same time of day as when they were taken. In some implementations, one or more of the current date and location are compared to the date and location associated with a photo as light levels and other environmental factors can vary tremendously based on these conditions. For example, light and weather conditions in the country of Norway at 8 pm in December are very different from conditions at 8 pm in July.

Another mechanism for changing the images based at least if′ part on the time of day 204 is to use the photo's color temperature to match the time of day in the room. For instance, in some implementations, images with warm colors are displayed in the morning and images with cool colors are displayed at night.

FIG. 2B shows how the images selected may change throughout the day, based at least in part on time of day. As illustrated in FIG. 2B, in some implementations, the image selection is optimized for similar light emission. For instance, in some implementations, at dawn 250 the image(s) displayed may include a pre-dawn image 260; in the morning 252 the image(s) displayed may include a sunrise image 262; at midday 254 the image(s) displayed may include midday image 264 such as a sparkling stream or other active natural scene; in the afternoon 256 the image(s) displayed may include an afternoon image 266 such as a tranquil lake or other calm natural scene; in the evening 258 the image(s) displayed may include a sunset 268 image; and at night 259 the image(s) displayed may include a moonlit image 269. In other words, as illustrated in FIG. 2B, in some implementations, the media content items (such as an image or slideshow of images) are displayed at the same time of day as when they were taken. In some implementations, as described above, in addition to time of day 204, the images are also selected based on one or more additional signals, such as date and location.

As also illustrated in FIG. 2B, in some implementations, the image that is displayed is selected based on color values that align to the natural world. For instance, in some implementations, at dawn 250 the image(s) displayed may include orange 270 as a major color; in the morning 252 the image(s) displayed may include yellow 272 as a major color, at midday 254 the image(s) displayed may include green 274 as a major color; in the afternoon 256 the image(s) displayed may include blue 276 as a major color; in the evening 258 the image(s) displayed may include a purple 278 as a major color; and at night 259 the image(s) displayed may include a gray 279 as a major color. As such, the media content items (such as an image or slideshow of images) that are displayed include major colors associated with the same time of day. The colors described above are examples of major colors associated with times of day in some implementations, but in other implementations different colors or groupings of colors are associated with particular times of day. The example colors in FIG. 2B are not meant to be limiting.

In some implementations, as illustrated in FIG. 2B, both qualities, e.g., both the time of day that the image was taken and the major color of the image are used in selecting a media content item to be displayed based on the time of day 202 of the room.

### Weather/Temperature 206

Referring to FIG. 2A, in some implementations, the weather/temperature condition 206 is also a type of environmental signal 202 that is obtained. In some implementations, weather/temperature 206 also includes information regarding season (obtained directly or determined based on current date and current geographic location). In some implementations, additional information such as ambient light level (e.g., state of lighting devices in the room and/or light from windows) and related color temperature of room, ambient sound level, and music selection, if any, are also obtained from various sensors and devices within the room to determine the current environmental conditions of the MOM.

Similar to the time of day analysis described above. The weather/temperature 206 information is used to determine a media content item with appropriate visual characteristics. In some implementations, the date stamp is used to match the EXIF data for a photograph selected for display. In some implementations, the color temperature of the media content item is selected to match the weather (e.g., rainy days), the season (e.g., autumn colors) and other environmental indicators. As described above, weather and temperature information (based on date and geographic location information) can be combined with the current time to select appropriate images for ambient display. For example, images can be selected with weather and geographical location similar to that of the user location based on environment signals and photo information providing current weather information and the current time, date and user geographical location.

### Image of Room 208

Acquiring environmental signals 202, also involves obtaining an image of the room 208. In some implementations, a photograph of the room is provided by the user and stored for future reference. In some implementations, the primary display screen device has a camera (or an ambient light sensor which is a simplified version of a camera). In still other implementations, a real-time image of the room is obtained from a separate device such as a video feed (e.g., security camera) located in the room. In any case, an image obtained which shows the room is utilized to identify and displayed media content items (e.g., photos) to match the room. For instance a room can be defined by its color pallet and its design style (e.g., red and modern, or brown and rustic). Then the proper images are displayed on the primary display screen to match the room's design style and/or color pallet. In some implementations, instead of utilizing an image of a room (e.g., when a room's image is not available) a user selected palette and theme are utilized instead. In some implementations, in addition to utilizing an image of the room 208, the user also has an option of selecting a theme or style.

In some implementations, the room style in which the primary display is located is identified from a photo using an image processing or machine learning operation in which features of the room, or portions of the room (as shown in one or more images), are compared against features associated with one or more of a predefined set of styles (for example, Mid-Century Modern, Victorian, or Craftsman) and then identified/classified as being characteristic of one (or a combination) of those predefined styles. In some implementations, features of the different predefined styles are determined by applying machine learning techniques to a set of images tagged by human experts as being good examples of each of the different predefined styles. The image processing or machine learning techniques that can be used in this sort of process include support vector machines, artificial neural networks, or any other known techniques in which computer devices are trained to recognize known image features or characteristics.

In some implementations, untrained image processing or machine learning techniques can be used. For example, clustering techniques, which are known, can be used to cluster images of rooms or room elements with a similar style. Each cluster can then be tagged by a human expert with a style description. Subsequently, a new image of a room (e.g., a room for which selection of images for ambient display is being performed) is assigned to a cluster using the same clustering techniques and then associated with the same style label as the cluster to which that room image was assigned. In some implementations, the image processing operations described herein are performed at a server (e.g., the server 400 of FIG. 1). In some implementations, a portion of the image processing operations described herein are performed locally (e.g., at the client 300 of FIG. 1).

In addition to identifying a room style, selecting an ambient image based on the room style includes selecting an appropriate image from an image database 408 (FIG. 1) in which at least some images have been tagged with a style. For example, the image database 408 can include a number of landscapes with different characteristics tagged as being compatible with a Victorian, Contemporary or Modern style. These images can also be tagged with one or more other image characteristics, such as color palette and color temperature, which can be used to match other environment signals (or in combination with style or other signal characteristics). In some implementations, the tagged database is stored at a server (e.g., the server 400 of FIG. 1). In some implementations, a portion of the tagged images (e.g., images with characteristics that match the identified room style and color palette) are stored locally (at the display screen controller 110 of FIG. 1).

### Theme from Phone/Device 210

In some implementations, the background or theme from another personal device such as a phone, PDA, tablet, digital picture frame etc. in the room is used to influence the selection of an appropriate image for display on the primary display screen. Often, other devices in the room will already have color themes or background images on their home screens. In this case, these other devices are queried for these themes and adjust the images shown to match the other devices. This can be especially helpful for adjusting the theme to a current occupant of the room. For instance, one resident of a home may prefer nature images while a second resident prefers classic art images. In such a situation, when a device associated with the first resident is in the room and a device associated with the second resident is not in the room, then the selected media content item(s) are influenced only by the preference in theme of the first resident, making the selection of images tend toward nature images. Similarly, in some implementations, other digital history from the secondary device is used to influence the selection of images. For instance, information regarding a design style can be inferred from a user's purchase history, browsing history, and collection of photos. Also, current calendar items also influence the selection of images. For instance, if a calendar item for brunch is coming up within a certain period of time (e.g., within one hour) images of brunch food or brunch related themes (flowers, sunshine, farm fields) or even advertisements for places that serve brunches may be selected for display on the primary display screen. These images can also be selected to match one or more other signals in combination, such as images that match the current room style, time of day and room color palette.

FIG. 2C illustrates a room 230, an image of which can be used to determine the room's style and color pallet as described above with respect to obtaining an image of the room 208. Specifically, the room also contains various items which are analyzes individually or together to determine the room's style and/or color pallet. For instance, the room 230 illustrated in FIG. 2C is a modern style with a black and white color pallet. Room items include: furniture 280, artwork 282, lighting fixtures 284, window coverings 286, and other displayed items 288. The room also includes a primary display screen 290, upon which a media content item with visual characteristics selected based on one or more of the design style and the color palette and the one or more environmental conditions is displayed. The room may also include a secondary device 292 such as a phone, reading device, PDA, tablet etc from which a color theme or background image can be obtained, as described above with respect to obtaining the theme from phone/device 210. In some implementations, various sensors 294 throughout the room are utilized to obtain information such as current time, ambient light level, and ambient sound level as described above with respect to obtaining the weather/temperature 206 and time of day 204.

Referring to FIG. 2A, after the environmental signals are acquired 202, image specifications are generated 212. In some implementations, image specifications include color, brightness and topic.

In some implementations, a database of media content items (such as images) is accessed 214. Attributes such as color, brightness, and topic are analyzed and the items are then appropriately tagged 216 according to the analyzed attributes. In some implementations, this image tagging is performed independently of selection of images for display on the primary screen.

Then once the image specifications have been generated at 212 for the room from the obtained environmental signals 202, images/items from the database are matched to specifications 218. Then the selected image(s)/item(s) are sent to the primary display screen and displayed 220.

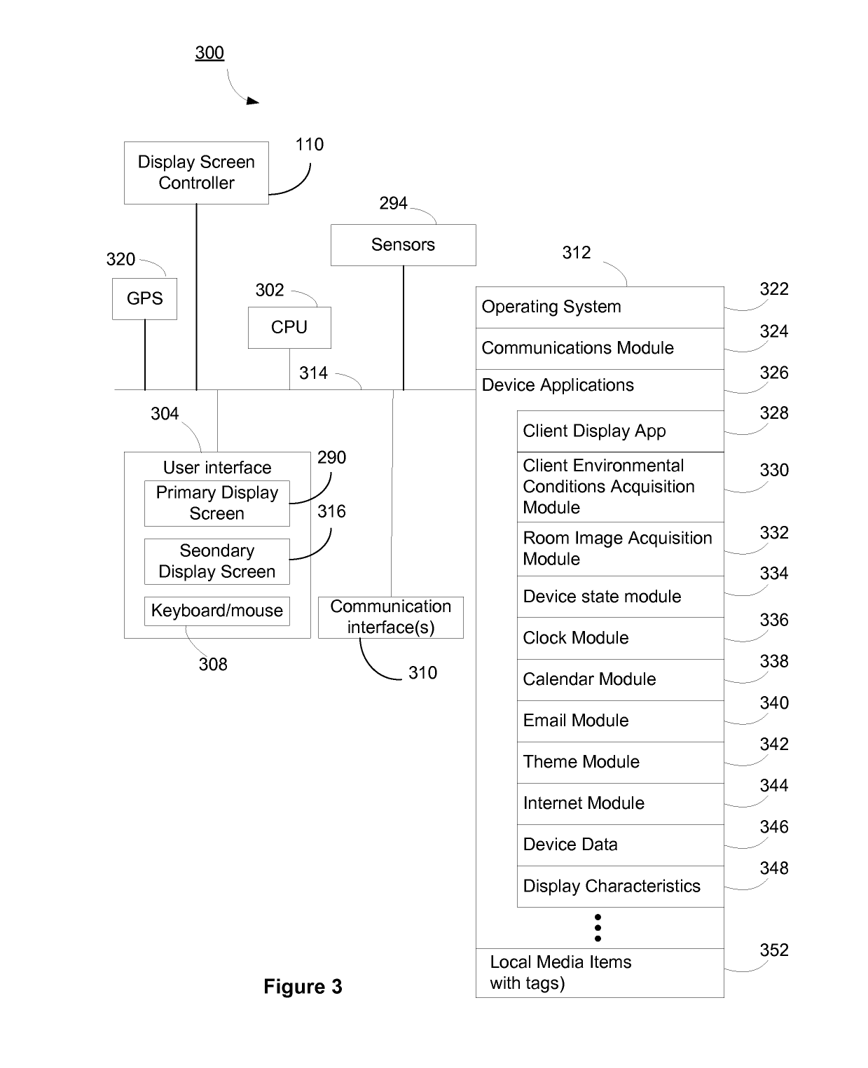

FIG. 3 is a block diagram illustrating a client device 300 (such as a device integrated with a primary display screen 290 or a display screen controller 110 that controls a separate primary display screen 290) in accordance with some implementations. In some implementations, the client device 300 is a set top box, a computer connected to the primary display screen 290, or processing capabilities integrated with the primary display screen 290 (such as Google TV enabled television). The client device 300 typically includes one or more processing units (CPU's) 302, one or more network or other communications interfaces 310, memory 312, and one or more communication buses 314 for interconnecting these components. The communication buses 314 optionally include circuitry (sometimes called a chipset) that interconnects and controls communications between system components. The client device 300 optionally includes a user interface 304, which can include the primary display screen 290, or which can optionally include a secondary display 316 separate from the primary display screen 290. The user interface 314 may include one or more input device(s) 308, such as a remote control, a keyboard, a mouse, touch sensitive display screen, or other input devices. In some implementations, the client 300 includes a GPS receiver 320 that determines and provides location information for the client device 300 and by extension the primary display screen 290. The client device may also include sensors 294 (in addition to other in-room sensors 294) for providing an image of the room, and sensing and providing information on environmental conditions, such as weather, temperature, light, and sound proximate to the client device 300 and the primary display screen 290.

The memory 312 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 312 optionally includes one or more storage devices remotely located from the CPU(s) 302. Memory 312, or alternately the non-volatile memory device(s) within memory 312, comprises a non-transitory computer readable storage medium. In some implementations, memory 312 or the computer readable storage medium of memory 312 stores the following programs, modules and data structures, or a subset thereof:
an operating system 322 that includes procedures for handling various basic system services and for performing hardware dependent tasks;
a network communication module 324 that is used for connecting the client 300 to other computers via the one or more communication network interfaces 310 (wired or wireless) and one or more communication networks, such as the Internet, other wide area networks, local area networks, metropolitan area networks, and so on;
one or more device applications 326 for controlling various functions on the device such as:
   a client display application 328, which receives a media content item(s) selected to match a theme/color of a room and which implements the display of the media content item(s) on the primary display screen 290, and which in some implementations also performs local processing such as analyzing some of the real-time environmental conditions of a room (e.g., based on signals obtained from one or more room sensors 294) and determining a design style associated with the room 230, and provides the analyzed information to the server 400;
   a client environmental conditions acquisition module 330, which obtains and provides to the server 400 (or to the client display application 328) one or more real-time environmental conditions of a room such as weather/temperature (e.g., any or all of a current date, current weather, geographic location, a current season, an ambient light level and related color temperature of room, and ambient sound level, and music selection from the room's sensors 294);
   a client room image acquisition module 332, for obtaining an image of a room from a user or from a sensor 294 such as a camera or video feed;
   a device state module 334 that provides information regarding the on/off state of a screen (as ambient images are generally displayed on an on but not active primary display screen);
   a clock 336 for tracking a current time and providing current time to a server 400 or the client display application 328;
   a calendar module 338, for tracking a user's appointments and calendar events;
   a email module 340, for sending and receiving email messages;
   a theme module 342 for storing a user's pre-set thematic preferences;
   a Internet browsing module 344 for connecting to internet pages for searching, browsing, and performing social networking activities;
   device data 346 such as device capabilities and other stored data associated with one or more of the display screen controller 110, the primary display screen 290 and room sensors 294; and
   display characteristics 348 associated with the primary display screen 290, such as orientation, number of pixels, color range etc.
local media items 352, which include media items that are suited to aspects of the room's environment, such as media items downloaded from the server media item database 408 that are compatible with the room's color palette and/or style and/or current environmental conditions, and media items that were created locally and tagged for ambient display on the primary display screen 290.

Each of the above identified elements is typically stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various implementations. In some implementations, memory 312 stores a subset of the modules and data structures identified above. Furthermore, memory 312 may store additional modules and data structures not described above.

In some implementations, personal devices 296 (FIG. 1) also include many of the hardware and software elements illustrated in FIG. 3. For example, a personal device 296 that is a smart phone could include all (or almost all) features of FIG. 3. One possible exception might be a direct connection to the primary display screen 290.

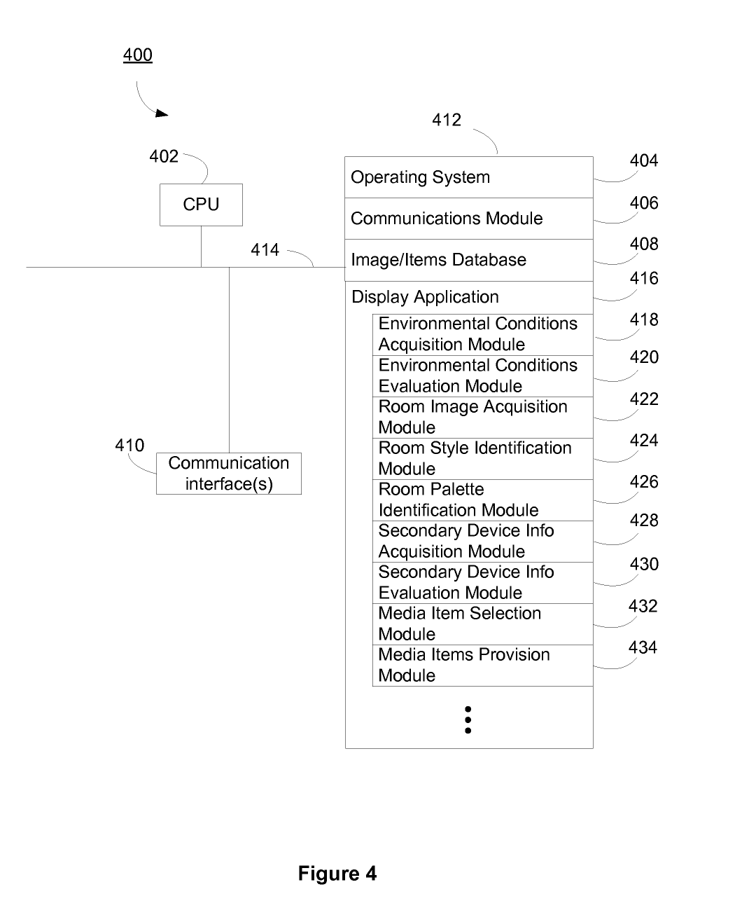

FIG. 4 is a block diagram illustrating a server 400 in accordance with some implementations. The server 400 typically includes one or more processing units (CPU's) 402, one or more network or other communications interfaces 410, memory 412, and one or more communication buses 414 for interconnecting these components. The communication buses 414 optionally include circuitry (sometimes called a chipset) that interconnects and controls communications between system components. The server 400 optionally includes a user interface (not shown) comprising a display device and one or more input device(s), such as a keyboard, a mouse, touch sensitive display screen, or other pointing device. Memory 412 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 412 optionally includes one or more storage devices remotely located from the CPU(s) 402. Memory 412, or alternately the non-volatile memory device(s) within memory 412, comprises a non-transitory computer readable storage medium. In some implementations, memory 412 or the computer readable storage medium of memory 412 stores the following programs, modules and data structures, or a subset thereof:
an operating system 404 that includes procedures for handling various basic system services and for performing hardware dependent tasks;
a network communication module 406 that is used for connecting the server 400 to other computers via the one or more communication network interfaces 410 (wired or wireless) and one or more communication networks, such as the Internet, other wide area networks, local area networks, metropolitan area networks, and so on;
a database of tagged media content items 408, including images such as photographs and drawings, and also include videos, advertisements, and other visually displayable item that are each tagged one or more tags, identifying one or more of: a first design style, a first color palette, brightness, a topic, and an overall color temperature associated with the respective media content item (this database can also be located remotely from the server 400 and accessed by the server 400 via a network connection);
a server display application 416 which obtain information about an environment surrounding a primary display screen and automatically selects media content items thematically appropriate for display on the screen when otherwise not in active use and selects appropriate environmental conditions acquisition module. In some implementations, the display application 416 includes at least some of the following modules and data structures:
   an environmental conditions acquisition module 418, which obtains one or more real-time environmental conditions of a room such as time and weather/temperature (e.g., any or all of a current date, current weather, geographic location, a current season, an ambient light level and related color temperature of room, and ambient sound level, and music selection);
   an environmental conditions evaluation module 420, which evaluates the one or real-time environmental conditions to determine image specifications for design style, color palette, brightness, topic, color temperature etc;
   a room image acquisition module 422, for obtaining an image of a room from a user or real-time from a device in the room;
   a room style identification module 424, for identifying a style (rustic, modern, classic, casual, etc) associated with the room based on various items in the room (e.g., furniture, artwork, lighting fixtures, window coverings, and other displayed item);
   a room palette identification module 426, for identifying room's color palette (single color or multiple colors) from at least a room image and sometime also from real-time environmental conditions such as time of day, season, lighting and color temperature);
   a secondary device information acquisition module 428, for obtaining various information such as background and theme from a secondary device such as a phone, PDA, music player, digital reader, digital picture frame, tablet etc). Other information obtained may include browsing history, current book selection, current music selection, calendar events;
   a secondary device information evaluation module 430, for evaluating information obtained from the secondary device for image specifications of media content items based on design style, color palette, brightness, topic, color temperature etc;
   a media content item selection module 432, for selecting appropriate media content items which have visual characteristics based on one or more of the real-time environmental conditions and the design style, color palette, and/or secondary device information; and
   a media content item provision module 434, for providing the selected media content item(s) for display on the primary display screen.

Each of the above identified elements is typically stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various implementations. In some implementations, memory 412 stores a subset of the modules and data structures identified above. Furthermore, memory 412 may store additional modules and data structures not described above.

Although FIG. 4 shows a “server system 400” and FIG. 3 shows a “client system 300” these figures are intended more as functional description of various features present in a set of servers than as a structural schematic of the implementations described herein. In practice, and as recognized by those of ordinary skill in the art, items shown separately could be combined and some items could be separated. For example, some items shown separately in FIG. 4 could be implemented on a single server and single items could be implemented by one or more servers. The actual number of servers used to implement a server system 400 and how features are allocated among them will vary from one implementation to another, and typically depend in part on the amount of data traffic that the system must handle during peak usage periods as well as during average usage periods.

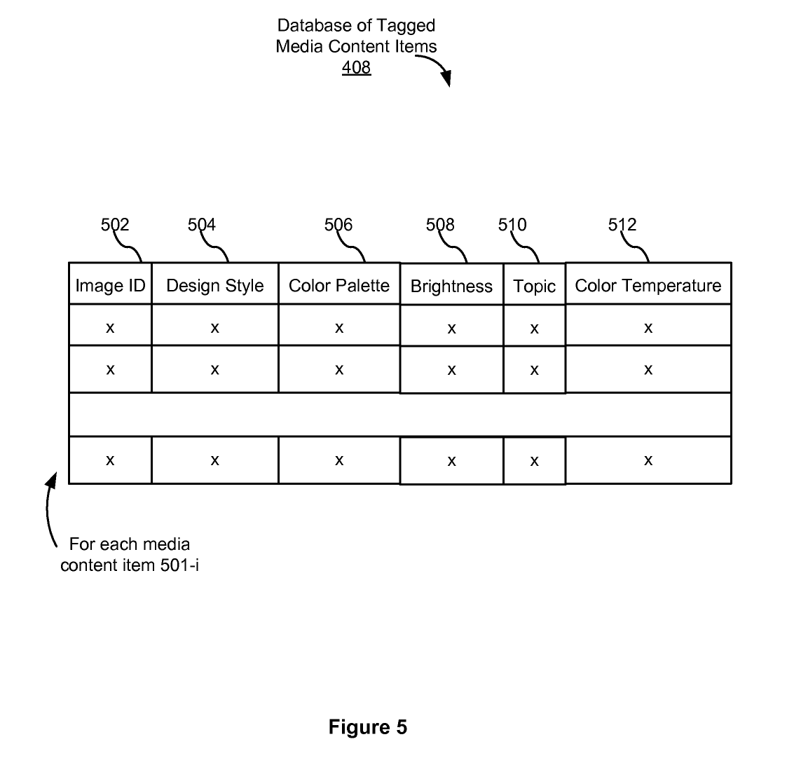

FIG. 5 is block diagram illustrating a data structure for a database 408 of tagged media content items 501. Media content items 501 include images such as photographs and drawings, and also include videos, advertisements, and other visually displayable items. Each item 501 in the database 408 is associated with an image ID 502. Each item 501 is also tagged with one or more tags that can be used to identify an appropriate image for display on the primary display device by matching 218 the image items in the database 408 to the generated image specifications 212 determined from the acquired environmental signals 202 (including real-time environmental signals 203 such as time of day 204 and weather/temperature 206 as well as the image of the room 208 and information such as theme from a secondary device 210 as discussed with respect to FIG. 2). In some implementations, the media content items 501 are each associated with tags identifying one or more of: a first design style 504, a first color palette 506, brightness 508, a topic 510, and an overall color temperature 512 associated with the respective media content item 501. It is noted that this database 408 can also be located at server 400 or remotely from the server 400 and accessed by the server 400 via a network connection. Portions of this database 408 can also

FIG. 6 is a flowchart representing a method 600 of providing media content item(s) for display on a primary display screen, wherein the media content items that match the theme of the display screen's surroundings, according to certain some implementations. The method 600 is typically governed by instructions that are stored in a computer readable storage medium and that are executed by one or more processors. The method takes place at a computer system having one or more processors and memory storing programs for execution by the one or more processors. For example, the display method 600 can be performed by the display application 416 (FIG. 1), either at a server 400, by an on-premises, display application 328 at a client device 300, or at some combination of the two.

One or more environmental conditions of a room (including real time environmental conditions) in which a primary display screen is located are evaluated (602). In some implementations, the primary display screen is controllable by computer system via one or more of a network or a client device coupled to the primary display screen. The one or more environmental conditions include any one of or any combination of: a current time, a current date, current weather (from a weather report or from sensor information), geographic location, a current season (obtained directly or determined based on current date and current geographic location), an ambient light level (e.g., state of lighting devices in the room and/or light from windows) and related color temperature of room, and ambient sound level, and music selection, if any (604). The environmental conditions can also include user-related information, such as current calendar appointments, media preferences and recent search queries. The environmental conditions (including real time environmental conditions) are obtained by sensors and devices in the room and other sources of current information. For instance the current time, season, and weather conditions can be obtained from external sources or can be obtained in whole or in part from sensors or devices in the room, such as a smart phone equipped with a microphone, GPS receiver, video/still camera, clock and weather app.

Additionally, either before or after the environmental conditions of the room are obtained, an image of the room is also obtained (606). For instance, in some implementations, a photograph of the room is provided by the user and stored for future reference. Alternatively, in some implementations, the primary display screen device has a camera or a separate device in the room contains a camera or video feed such that the image of the room is also obtained in real-time.

The design style associated with the room is identified from at least one obtained image of the room (608). For instance a room's design style can be defined by various items found in the room such as furniture, artwork, lighting fixtures, window coverings, and other displayed items illustrated for example with respect to FIG. 2C. Examples of design style are rustic, modern, classic, casual, etc. Typically, the room's design style needs to be identified only once, so results of this identification operation can be performed once (e.g., by the server 400 and/or by the screen controller 110) and the resulting style information saved for later use—e.g., whenever the process for identifying a collection of images for ambient presentation on the primary display screen 290 is performed. Consequently, reference herein to identifying the room's design style can refer to an initial identification step, involving image analysis of at least one image of the room, or a subsequent identification step involving reference to a design style saved from a previous initial identification step.

Furthermore, in some implementations, the room's color palette is also is identified (610). In some implementations, the room's color palette is identified from at least one obtained image of the room. In other implementations, the room's color palette is also identified based on various real-time environmental conditions (e.g., time of day, lighting level, color temperature, season etc.) Examples of color palate are single colors such as brown, black, red, green etc, as well as color combinations such as white/black/red, brown/green, blue/green, yellow/white/blue, and red/gold etc. Typically, the room's color palette needs to be identified only once, so results of this identification operation can be performed once (e.g., by the server 400 and/or by the screen controller 110) and the resulting color palette information saved for later use—e.g., whenever the process for identifying a collection of images for ambient presentation on the primary display screen 290 is performed. Consequently, reference herein to identifying the room's color palette can refer to an initial identification step, involving image analysis of at least one image of the room, or a subsequent identification step involving reference to a color palette saved from a previous initial identification step.

Additionally, in some implementations, if a secondary electronic device (phone, PDA, tablet, digital picture frame, music device, digital reader, etc) is in the room, it assessed for a background or theme or other information such as browsing history, current book selection, current music selection, calendar events. In some implementations, the information such as background images and themes from the secondary device(s) are utilized to identify a room theme (612).

One or more appropriate media content items are selected, which have visual characteristics based on (e.g., compatible with or complimentary to) one or more of the real-time environmental conditions and the design style and/or the color palette (614). Media content items include images such as photographs and drawings, and also include videos, advertisements, and other visually displayable items. In some implementations, a database including a plurality of media content items is accessed and an appropriate item is selected (615). In some implementations, each media content item is associated with one or more tags, identifying one or more of: a first design style, a first color palette, brightness, a topic, and an overall color temperature associated with the respective media content item. The appropriate media content item(s) are selected from one or more of the media content items with tags that are complimentary to the one or more real-time environmental conditions and the design style or the color palette. It is noted that in some implementations, the image database includes a collection of images designated by a user with an associated location that coincides with a location of the room.

Then the media content item(s) with visual characteristics which were selected based on the one or more real-time environmental conditions and the design style and/or the color palette and are then sent to the primary display screen for display (616).

In some implementations, at (612) one or more of an Internet browsing history and a search history are received from a secondary device. Furthermore, in some implementations, the Internet browsing history and search history are associated with a location that coincides with a location of the room. In these implementations, at (614) one or more advertisements are selected based in part on the Internet browsing history and the search history. In some implementations, advertisements may also be selected based on calendar items. A subset of the one or more advertisements with tags that are complimentary to the one or more real-time environmental conditions and one or more of the design style and the color palette are then selected. Then at (616) the subset of the one or more advertisements is sent to the primary display screen as the media content item.

In some implementations, evaluating the one or more real time environmental conditions of the room at (602) includes identifying a music style of music heard in the room, and sending to the primary display screen for display the media content item at (616) includes sending to the primary display screen a media content item with visual characteristics based on one or more of the design style, the color palette, and the music style.

In some implementations, the room includes speakers, and the method further comprises causing the speakers to perform a music item with a musical style that is compatible with the one or more of the design style and the color palette (618).

In some implementations, prior to performing any of the above outlined method, the system first identifies whether the primary display screen is on or off and whether it is active or inactive, and it performs the above described method if the primary display is on and inactive, and does not perform the method if the primary display screen is or is on and actively displaying other content (e.g., the user is currently watching a movie).

In some implementations, in connection with identifying a design style or theme associated with a room at (612) one or more objects in the room are recognized. Then the recognized/identified object(s) are used to identify the room's style. For instance, a glass coffee table may indicate a modern style, while an antique chair may indicate a Victorian style. In some implementations, objects with a room's image are individually visually recognized by matching them with a database of object images. Objects can include furniture 280, artwork 282, lighting fixtures 284, window coverings 286, and other displayed items 288 discussed with respect to FIG. 2C, and can also include exercise equipment, books, cleaning products, food and drinks (especially if packaging logos can be identified), bikes, skateboards, and the like. The recognized objects are then tagged with particular style(s), and an average or weighted average of the styles of the recognized objects is used in identifying a style associated with the room. In some implementations, the recognized items are also used to directly influence the selection of media content images when the images include an advertisement nature (e.g., products advertised may be of a similar brand to that of an object recognized in the room.)

In some implementations, in connection with identifying a design style or theme associated with a room at (612) a user's digital history is accessed. Some digital history information may be accessed from a primary display screen's device (e.g., a smart TV device) other digital history information may be accessed from a secondary device such as a computer, tablet, smart phone, digital picture frame etc. depending on the embodiment. In some implementations, digital history information includes previous purchases (e.g., a purchase of an antique rocking chair). In some implementations, digital history also includes photographs or images, such as personal photographs, or images selected to be displayed in a digital picture frame (such as images of modern architecture or pointillism style artwork). Additionally, in some implementations, digital history also includes browsing history (e.g., if a user visits skating websites, it may be determined that the room is a “skater” room style.) Furthermore, in some implementations, the digital history information is also used to directly influence the selection of media content images (whether those are advertisements or relaxation images (e.g., artwork also by Vincent van Gogh if one or more Vincent van Gogh images are already displayed within a slideshow of digital picture frame in the room.)

Each of the operations shown in FIG. 6 typically corresponds to instructions stored in a computer memory or non-transitory computer readable storage medium. The computer readable storage medium typically includes a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. Specifically many of the operations shown in FIG. 6 correspond to instructions in the display application 416 of the server system 400 shown in FIG. 4.

The terminology used in the description of the implementations herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” as well as the terms “includes” and/or “including” when used in this specification, specify the presence of stated features, integers, steps, operations, elements, and/or components, but do not preclude the presence or addition of one or more other features, integers, steps, operations, elements, components, and/or groups thereof.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the first element are renamed consistently and all occurrences of the second element are renamed consistently. The first element and the second element are both elements, but they are not the same element.

As used herein, the term “if” may be construed to mean “when” or “upon” or “in response to,” depending on the context. Similarly, the phrase “if it is determined” or “if (a stated condition or event]) is detected” may be construed to mean “upon determining” or “in response to determining” or “upon detecting (the stated condition or event)” or “in response to detecting (the stated condition or event),” depending on the context.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A computer-implemented method, comprising:
at a computer system including one or more processors and memory storing programs for execution by the one or more processors:
evaluating one or more environmental conditions of a room in which a primary display screen is located, wherein the environmental conditions include: current time, current date, current season, geographic location, ambient light level and color temperature, and ambient sound level;
identifying a design style associated with the room; and
sending to the primary display screen for display a media content item with visual characteristics based on one or more of the design style and the one or more environmental conditions.

2. The computer-implemented method of claim 1, further comprising:
identifying a color palette associated with the room; and
sending to the primary display screen for display a media content item with visual characteristics based on one or more of the design style and the color palette and the one or more environmental conditions.

3. The computer-implemented method of claim 1, further comprising:
accessing a database including a plurality of media content items, wherein each of the plurality of media content items is associated with one or more tags identifying one or more of: a first design style, a first color palette, a brightness, a topic, and an overall color temperature associated with the respective media content item; and
selecting a media content item from one or more of the media content items with tags that are compatible with the one or more environmental conditions and the design style.

4. The computer-implemented method of claim 1, further comprising:
receiving one or more of an Internet browsing history and a search history for a user with an associated location that coincides with a location of the room;
selecting one or more advertisements based on the Internet browsing history and the search history;
selecting a subset of the one or more advertisements with tags that are compatible with the one or more environmental conditions and one or more of the design style and the color palette; and
sending the subset of the one or more advertisements to the primary display screen as the media content item.

5. The computer-implemented method of claim 1, further comprising:
receiving a search query from a user with an associated location that coincides with a location of the room;
selecting one or more advertisements based on the search query;
selecting a subset of the one or more advertisements with tags that are compatible with the one or more environmental conditions and one or more of the design style and the color palette; and
sending the subset of the one or more advertisements to the primary display screen as the media content item.

6. The computer-implemented method of claim 3, wherein the database includes a collection of images designated by a user with an associated location that coincides with a location of the room.

7. The computer-implemented method of claim 1, wherein:
evaluating the one or more environmental conditions of the room includes identifying a music style of music heard in the room, and
sending to the primary display screen for display the media content item includes sending to the primary display screen a media content item with visual characteristics based on one or more of the design style, the color palette, and the music style.

8. The computer-implemented method of claim 1, wherein the room includes environmental sensors, further comprising:
collecting from the environmental sensors information pertaining to the environmental conditions in real-time.

9. The computer-implemented method of claim 1, further comprising:
identifying whether the primary display screen is inactive; and
performing the method if the primary display is inactive and not performing the method if the primary display screen is active.

10. The computer-implemented method of claim 1, wherein the primary display screen is a networked to a separate display screen control device that locally processes one or more of the environmental conditions and that controls display of media content items on the display screen.

11. The computer-implemented method of claim 1, further comprising:
identifying a specific object in the room; and
identifying a design style associated with the room based in part on the identified object.

12. The computer-implemented method of claim 1, further comprising:
accessing digital history for a user with an associated location that coincides with a location of the room, wherein the digital history includes one or more of: purchases, photographs, and internet browsing history; and
identifying a design style associated with the room based in part on the digital history the user.

13. A computer system, comprising:
one or more processors; and
memory storing one or more programs to be executed by the one or more processors;
the one or more programs comprising instructions for:
evaluating one or more environmental conditions of a room in which a primary display screen is located, wherein the one or more environmental conditions include: current time, current date, current season, geographic location, ambient light level and color temperature, and ambient sound level;
identifying a design style associated with the room from at least one image of the room; and
sending to the primary display screen for display a media content item with visual characteristics based on one or more of the design style and the one or more real-time environmental conditions.

14. The computer system of claim 13, further comprising instructions for:
identifying a color palette associated with the room; and
sending to the primary display screen for display a media content item with visual characteristics based on one or more of the design style and the color palette and the one or more environmental conditions.

15. The computer system of claim 13, further comprising instructions for:
accessing a database including a plurality of media content items, wherein each of the plurality of media content items is associated with one or more tags, identifying one or more of: a first design style, a first color palette, a brightness, a topic, and an overall color temperature associated with the respective media content item; and
selecting a media content item from one or more of the media content items with tags that are compatible with the one or more environmental conditions and the design style.

16. The computer system of claim 15, wherein the database includes a collection of images designated by a user with an associated location that coincides with a location of the room.

17. A non-transitory computer readable storage medium storing one or more programs configured for execution by a computer, the one or more programs comprising instructions for:
evaluating one or more environmental conditions of a room in which a primary display screen is located, wherein the one or more environmental conditions include: current time, current date, current season, geographic location, ambient light level and color temperature, and ambient sound level;
identifying a design style associated with the room from at least one image of the room; and
sending to the primary display screen for display a media content item with visual characteristics based on one or more of the design style and the one or more environmental conditions.

18. The non-transitory computer readable storage medium of claim 17, further comprising instructions for:
identifying a color palette associated with the room; and
sending to the primary display screen for display a media content item with visual characteristics based on one or more of the design style and the color palette and the one or more environmental conditions.

19. The non-transitory computer readable storage medium of claim 17, further comprising instructions for:
accessing a database including a plurality of media content items, wherein each of the plurality of media content items is associated with one or more tags, identifying one or more of: a first design style, a first color palette, a brightness, a topic, and an overall color temperature associated with the respective media content item; and
selecting a media content item from one or more of the media content items with tags that are compatible with the one or more environmental conditions and the design style.

20. The non-transitory computer readable storage medium of claim 19, wherein the database includes a collection of images designated by a user with an associated location that coincides with a location of the room.
